(19) United States
(12) Patent Application Publication
(10) Pub. No.: US 2011/0216228 A1
(43) Pub. Date: Sep. 8, 2011

(54) SOLID-STATE IMAGE SENSING ELEMENT, METHOD FOR DRIVING SOLID-STATE IMAGE SENSING ELEMENT AND IMAGE PICKUP DEVICE

(75) Inventors: Noriko KAWAMURA, Saitama (JP); Tomoyuki KAWAI, Saitama (JP)

(73) Assignee: FUJIFILM CORPORATION, Tokyo (JP)

(21) Appl. No.: 12/880,284

(22) Filed: Sep. 13, 2010

(30) Foreign Application Priority Data
Sep. 14, 2009 (JP) 2009-211681

(51) Int. Cl. H04N 5/335

(52) U.S. Cl. 348/273; 348/296; 348/294; 348/E05.091

(57) ABSTRACT

A solid-state image sensing element includes a plurality of pixels, a color filter, a plurality of vertical charge transfer paths, a plurality of readout electrode portions. The pixels are formed on one face of a semiconductor substrate in a two-dimensional array arrangement. The color filter corresponds to a plurality of colors and includes a plurality of color filter elements disposed color by color on the pixels respectively so as to be arranged as a mosaic pattern as a whole. The vertical charge transfer paths are formed one by one between two of pixel columns composed of the pixels so that each of the vertical charge transfer paths transfers signal corresponding to one of the colors. The readout electrode portions connect each of the vertical charge transfer paths to pixels arranged in both sides of each of the vertical charge transfer paths.

### CROSS-REFERENCE TO RELATED APPLICATIONS

This application is based upon and claims the benefit of priority from Japanese Patent Application No. 2009-211681, filed Sep. 14, 2009.

### BACKGROUND

1. Technical Field

The present invention relates to a CCD type solid-state image sensing element, a method of driving the same and an image pickup device.

2. Related Art

In a solid-state image sensing element for picking up a color image, color filters are laminated on a plurality of photo acceptance elements (pixels) formed and arranged as a two-dimensional array on a surface portion of a semiconductor substrate so that the quantity of accepted light transmitted through each color filter is detected by a corresponding one of the pixels.

When, for example, a single plate type solid-state image sensing element is equipped with primary color filters, a color filter of any one color selected from R (red), G (green) and B (blue) is laminated on each of the pixels arranged as a two-dimensional array.

Because a pixel (R pixel) provided with an R filter does not detect any color signals but a color signal corresponding to the quantity of accepted red light, a color signal of G light in the position of this R pixel is calculated by interpolating detected signals of G pixels around this R pixel while a color signal of B light is calculated by interpolating detected signals of B pixels around this R pixel.

Various arrangements are used as the color arrangement of the laminated color filters in the single plate type solid-state image sensing element. For example, a color filter arrangement called vertical stripe color filter arrangement is used in a solid-state image sensing element described in JP-A-9-55892 and JPA-2000-125310. The vertical stripe color filter arrangement is a color filter arrangement in which lamination of color filters of one color (e.g. R) on a vertical column of pixels in the pixels arranged as a two-dimensional array, lamination of color filters of another color (e.g. G) on a next column of pixels and lamination of color filters of a further color (e.g. B) on a further next column of pixels are repeated so that the color filters are arranged as RGBRGB . . . in a row direction.

When the vertical stripe color filter arrangement is viewed in the column direction, respective pixels in the column direction detect color signals of the same color so that resolution of this color becomes high. However, when the vertical stripe color filter arrangement is viewed in the row direction (horizontal direction), this color is detected by one pixel per three pixels so that there is a case of degradation of resolution.

As another color filter arrangement, there is a Bayer arrangement which is, for example, used in a solid-state image sensing element disclosed in JPA-2000-50290. The Bayer arrangement is a color filter arrangement in which three colors RGB are arranged in a mosaic pattern on a two-dimensional plane so that pixel rows arranged as RGRGRG . . . and pixel rows arranged as GBGBGB . . . are provided alternately in a row direction.

As a further color filter arrangement, there is an arrangement used in a solid-state image sensing element described in JP-A-2001-352554. This solid-state image sensing element uses a so-called honeycomb pixel arrangement in which: odd-numbered pixel rows are formed so as to be shifted by a half pixel pitch from even-numbered pixel rows; horizontal-striped G filters are laminated on the odd-numbered pixel rows; and color filter rows arranged in order of RBRBRB . . . and color filter rows arranged in order of BRBRBR . . . are provided alternately on the even-numbered pixel rows. This color filter arrangement is mosaic with respect to R and B.

As a further color filter arrangement, there is an arrangement used in a solid-state image sensing element described in JP-A-2004-55786 and JP-A-2009-60342. This solid-state image sensing element is also provided with a so-called honeycomb pixel arrangement. However, when only pixels in odd-numbered rows are viewed, the respective pixels are arranged in a tetragonal lattice pattern and color filters arranged as a Bayer arrangement are laminated on the pixels. When only pixels in even-numbered rows are viewed, the respective pixels are also arranged in a tetragonal lattice pattern and color filters arranged as a Bayer arrangement are laminated on the pixels.

When this color filter arrangement is viewed as a whole, oblique G-striped color filters are laminated on alternate oblique lines while lines arranged in order of RRBBRR . . . and lines arranged in order of BBRRBB . . . are provided alternately as the remaining lines so that the color filter arrangement is mosaic with respect to R and B.

Various color filter arrangements may be applied to a single plate type solid-state image sensing element for picking up a color image. The vertical stripe (or horizontal stripe) color filter arrangement, however, has excessively large difference between resolution in a row (horizontal) direction and a column (vertical) direction so that the mosaic color filter arrangement is prevail at present.

The mosaic color filter arrangement, however, has a case when the mosaic color filter arrangement is applied to a CCD type solid-state image sensing element in which the number of pixels has increased recently. This is because ten millions or more of pixels are mounted in the recent solid-state image sensing element so that each pixel is so minute that the amount of saturation charges in the pixel becomes small.

In the CCD type solid-state image sensing element, signal charges detected by pixels arranged in a column direction are read out onto a vertical charge transfer path provided along this pixel column, and transferred. Because transfer efficiency of 100% is physically impossible, charges remaining behind transfer are always generated so that the remaining charges of signal charges transferred previously are mixed with signal charges transferred newly.

In the CCD type solid-state image sensing element using the mosaic color filter arrangement, signal charges of different colors are transferred by the same vertical charge transfer path. Color mixing occurs when the charges remaining behind transfer are mixed with signal charges transferred newly. Although this color mixing is not problematic when the amount of saturation charges in each pixel is so large that the amount of signal charges is large, this color mixing becomes a disadvantage to cause degradation of image quality when each pixel is so minute that the amount of signal charges is small.

### SUMMARY OF THE INVENTION

According to an aspect of the invention, a solid-state image sensing element includes a plurality of pixels, a color filter, a plurality of vertical charge transfer paths, a plurality of readout electrode portions. The pixels are formed on one face of a semiconductor substrate in a two-dimensional array arrangement. The color filter corresponds to a plurality of colors and includes a plurality of color filter elements disposed color by color on the pixels respectively so as to be arranged as a mosaic pattern as a whole. The vertical charge transfer paths are formed one by one between two of pixel columns composed of the pixels so that each of the vertical charge transfer paths transfers signal corresponding to one of the colors. The readout electrode portions connect each of the vertical charge transfer paths to pixels arranged in both sides of each of the vertical charge transfer paths and are provided only between the vertical charge transfer path transferring signal corresponding to given color and the pixels on which the color filters corresponding to the given color is disposed.

### BRIEF DESCRIPTION OF THE DRAWINGS

FIG. 1 shows a block diagram of an image pickup device according to an exemplary embodiment of the invention.

FIG. 2 shows a schematic surface view of a CCD type solid-state image sensing element shown in FIG. 1.

FIG. 3 is a timing chart showing an example of a method for driving the CCD type solid-state image sensing element shown in FIG. 2.

FIG. 4 shows a state of signal charge readout/transfer based on the driving method explained in FIG. 3.

FIG. 5 shows a state of signal charge readout/transfer following FIG. 4.

FIG. 6 shows a state of signal charge readout/transfer following FIG. 5.

FIG. 7 shows a state of pixel addition and readout in the CCD type solid-state image sensing element shown in FIG. 2.

FIG. 8 shows a schematic surface view of a CCD type solid-state image sensing element according to another exemplary embodiment in place of FIG. 2.

FIG. 9 is an explanatory view showing a state of pixel addition in a line memory shown in FIG. 8.

FIG. 10 is an explanatory view showing a procedure of pixel addition using the line memory shown in FIG. 8 and a horizontal charge transfer path.

FIG. 11 is a driving timing chart showing an example of signal output of the CCD type solid-state image sensing element shown in FIG. 2 or 8.

FIG. 12 is a flow chart showing a procedure of preview display for user's confirmation of a still image after the image is picked up.

FIG. 13A shows schematic surface view of a CCD type solid-state image sensing element according to the background art.

FIG. 13B shows a driving timing chart for driving the CCD type solid-state image sensing element.

FIG. 14A shows a driving timing chart according to another exemplary embodiment of the invention.

FIG. 14B shows a driving timing chart according to the related art.

FIG. 15A shows a driving timing chart in a motion image pickup mode according to another exemplary embodiment of the invention.

FIG. 15B shows a driving timing chart according to the related art.

FIG. 16 shows a schematic surface view of a CCD type solid-state image sensing element according to another exemplary embodiment of the invention.

### DETAILED DESCRIPTION

An exemplary embodiment of the invention will be described below with reference to the drawings.

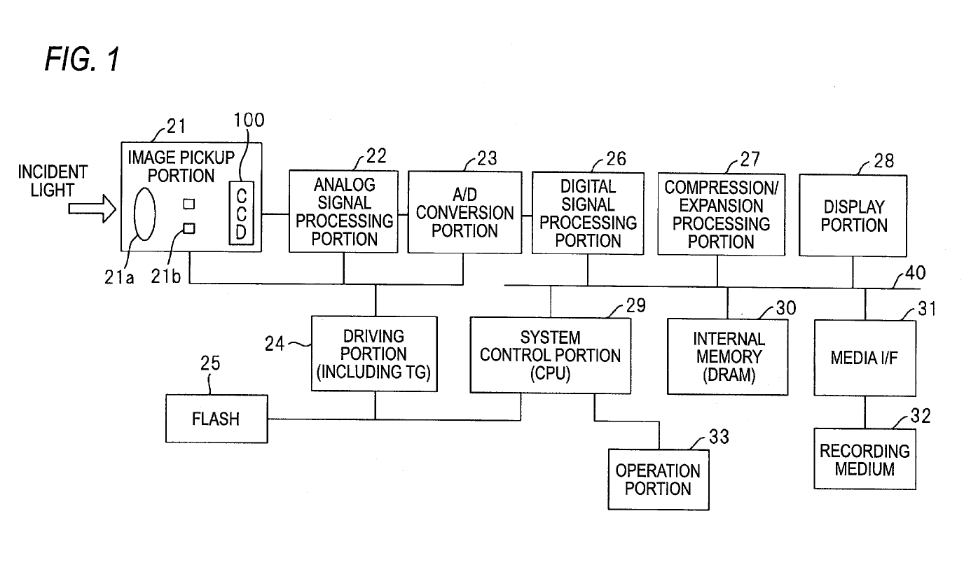

FIG. 1 is a functional block diagram of a digital camera according to an exemplary embodiment of the invention. The digital camera includes: an image pickup portion 21; an analog signal processing portion 22 for applying analog processing such as automatic gain control (AGC), correlated double sampling (CDS), etc. to analog image data outputted from the image pickup portion 21; an analog-to-digital conversion portion (A/D) 23 for converting the analog image data outputted from the analog signal processing portion 22 into digital image data; a driving portion (including a timing generator TG) 24 for performing drive control of the A/D 23, the analog signal processing portion 22 and the image pickup portion 21 based on an instruction given from a system control portion (CPU) 29 which will be described later; and a flash 25 for emitting light based on an instruction given from the CPU 29.

The image pickup portion 21 has: an optical lens system 21a for collecting light from a camera's field of view; a mechanical shutter 21b used as an iris for controlling a lens aperture to stop light passing through the optical lens system 21a or at the time of picking up a still image; and a single-plate CCD type solid-state image sensing element 100 for color image pickup which receives light collected by the optical lens system 21a and stopped by the iris and outputs picked-up image data (analog image data).

The digital camera according to this exemplary embodiment further includes: a digital signal processing portion 26 for fetching digital image data outputted from the A/D 23 and performing an interpolating process, a white balance correction and RGBNC conversion process, a process of synthesizing detected signals of first and second pixel groups which will be described later, etc. on the digital image data; a compression/expansion processing portion 27 for compressing the image data into image data in JPEG-format or the like or expanding compressed image data; a display portion 28 for displaying a menu or the like or displaying a through image and a picked-up image; a system control portion (CPU) 29 for generally controlling the whole of the digital camera; an internal memory 30 such as a frame memory; a media interface (I/F) portion 31 for performing interface processing between the digital camera and a recording medium 32 storing JPEG image data or the like; and a bus 40 for connecting these portions to one another. An operation portion 33 for inputting a user's instruction is connected to the system control portion 29.

The user operation portion 33 has: instruction switches for selecting an image pickup mode from a still image pickup mode and a motion image pickup mode and selecting a high-definition image pickup mode, a high-sensitivity image pickup mode, a wide dynamic range image pickup mode, etc.; a dynamic range width designation button; and a shutter release button. The CPU 29 performs drive control of the solid-state image sensing element 100 through the image pickup element driving portion 24 in accordance with contents inputted from the user operation portion 33.

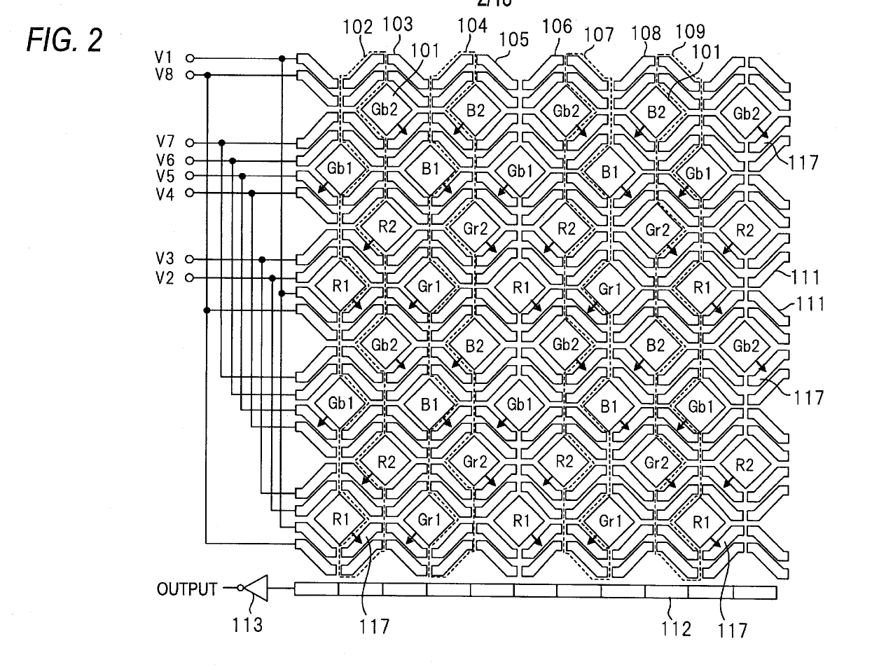

FIG. 2 is a schematic surface view of the solid-state image sensing element 100. In the digital camera according to this exemplary embodiment, a CCD type solid-state image sensing element of a so-called honeycomb pixel arrangement in which pixels are arranged in a checkered pattern is used as the solid-state image sensing element 100.

A plurality of photoelectric conversion elements (photodiodes PD's, hereinafter referred to as pixels) 101 are formed and arranged as a two-dimensional array in a surface portion of a semiconductor substrate. The array is formed in such a manner that even-numbered rows of pixels are shifted by a half pixel pitch from odd-numbered rows of pixels, respectively.

When only the even-numbered rows (or odd-numbered rows) of pixels (hereinafter referred to as first pixel group) are viewed, the respective pixels (photoelectric conversion elements) are arranged in a tetragonal lattice and primary color filters (R1=red, Gb1, Gr1=green, B1=blue) are formed as a Bayer arrangement in accordance with the tetragonal lattice arrangement. When only the odd-numbered rows (or even-numbered rows) of pixels (hereinafter referred to as second pixel group) are viewed, the respective pixels are arranged in a tetragonal lattice and color filters (R2=red, Gb2, Gr2=green, B2=blue) are formed as a Bayer arrangement in accordance with the tetragonal lattice arrangement.

In FIG. 2, the symbols R1, R2, B1, B2, Gb1, Gb2, Gr1 and Gr2 designate color filters, and the last numeral “1” or “2” of each symbol indicates whether the pixel belongs to the first pixel group or the second pixel group.

The symbol Gb1 designates a G pixel which is located in the same pixel row as B1 and equipped with a G filter. The symbol Gb2 designates a G pixel which is located in the same pixel row as B2 and equipped with a G filter. The symbol Gr1 designates a G pixel which is located in the same pixel row as R1 and equipped with a G filter. The symbol Gr2 designates a G pixel which is located in the same pixel row as R2 and equipped with a G filter. Consequently, the color filter arrangement in this exemplary embodiment is formed so that the colors of adjacent pixels change on alternate pixels both in a vertical direction and in a horizontal direction, and that pixels of the same color come at constant periods.

Embedded channels of vertical charge transfer paths (VCCD's) . . . 102, 103, 104, 105, 106, 107, 108, 109 . . . (among which, only the vertical charge transfer paths 102, 104, 107 and 109 are represented by dot lines in FIG. 2) are formed vertically (lengthwise) so as to meander along respective meandering pixel columns of the pixels 101 arranged in a checkered pattern. Vertical transfer electrode films 111 extending horizontally through gate insulating films not shown are formed on the embedded channels (on the surface of the semiconductor substrate) so as to meander. The embedded channels, the gate insulting films and the vertical transfer electrode films form vertical charge transfer paths (VCCD's). Two vertical transfer electrode films 111 are provided between obliquely adjacent pixels 101. That is, a pair of upper and lower vertical transfer electrode films 111 are adjacent to one pixel 101.

A horizontal charge transfer path (HCCD) 112 is provided along respective transfer-direction end portions of the vertical charge transfer paths 102 to 109. An amplifier 113 which outputs a voltage value signal corresponding to the amount of transferred signal charges as a picked-up image signal is provided in an output end portion of the horizontal charge transfer path 112.

This exemplary embodiment is characterized by directions of provision of readout electrodes serving also as vertical transfer electrodes in the respective pixels 101, and in that arrows coming out from the respective pixels 101 are not unidirectional, as shown in FIG. 2. That is, in this exemplary embodiment, directions of provision of readout electrode portions 117 are determined so that the vertical charge transfer paths 102 to 109 are used as transfer paths only used for specific color signal charge transfer, respectively.

The vertical charge transfer path 102 is an R color only signal charge transfer path. A readout electrode for a pixel 101 equipped with an R filter among pixels between which the vertical charge transfer path 102 is put is provided on the vertical charge transfer path 102 side. Readout electrode portions 117 for other pixels are provided on a side opposite to the vertical charge transfer path 102.

That is, the physical structure of the solid-state image sensing element 100 in this exemplary embodiment allows only R pixels to be connected to the R color only signal charge transfer path but prevents G pixels and B pixels from being connected to the R color only signal charge transfer path. The same rule also applies to any other color only signal charge transfer path which will be described later.

The vertical charge transfer path 103 adjacent to the vertical charge transfer path 102 is a G color only signal charge transfer path. A readout electrode portion 117 for a pixel 101 equipped with a G filter among pixels between which the vertical charge transfer path 103 is put is provided on the vertical charge transfer path 103 side. Readout electrode portions 117 for other pixels are provided on a side opposite to the vertical charge transfer path 103.

The vertical charge transfer path 104 adjacent to the vertical charge transfer path 103 is a B color only signal charge transfer path. A readout electrode portion 117 for a pixel 101 equipped with a B filter among pixels between which the vertical charge transfer path 104 is put is provided on the vertical charge transfer path 104 side. Readout electrode portions 117 for other pixels are provided on a side opposite to the vertical charge transfer path 104.

The vertical charge transfer path 105 adjacent to the vertical charge transfer path 104 is a G color only signal charge transfer path. A readout electrode portion 117 for a pixel 101 equipped with a G filter among pixels between which the vertical charge transfer path 105 is put is provided on the vertical charge transfer path 105 side. Readout electrode portions 117 for other pixels are provided on a side opposite to the vertical charge transfer path 105.

That is, in the solid-state image sensing element 100 in this exemplary embodiment, the vertical charge transfer paths are arranged cyclically in order of R only, G only, B only, G only, R only, G only, . . . , (RGBG) so that vertical charge transfer paths only used for G are provided on alternate columns while vertical charge transfer paths only used for R and vertical charge transfer paths only used for B are provided alternately on the other alternate columns. Although the color filter arrangement is formed as a mosaic pattern in which color filters of at least two colors of the three colors are arranged finely in periodic and discrete positions, the vertical charge transfer path arrangement is formed as an arrangement in which signal charge of only one color is transferred through each vertical charge transfer path. For example, a certain number of R pixels (pixels 101 equipped with R filters) in a left pixel column and the same number of R pixels in a right pixel column are connected to each other on the virtual charge transfer path only used for R.

Electrodes V1, V8, V7, V6, V5, V4, V3, V2, V1, V8, . . . , are connected in descending order to respective vertical transfer electrodes extending horizontally and arranged vertically in the solid-state image sensing element 100 shown in FIG. 2. Wiring connection of the electrodes is repeated in such a manner that the electrode V7 is connected to the readout electrode portion 117 of a pixel row (Gb2, B2, Gb2, B2, . . . ) shown in the uppermost stage of FIG. 2, the electrode V5 is connected to the readout electrode portion 117 of a pixel row (Gb1, B1, Gb1, B1, . . . ) in the second stage of FIG. 2, the electrode V3 is connected to the readout electrode portion 117 of a pixel row (R2, Gr2, R2, Gr2, . . . ) in the third stage of FIG. 2, and the electrode V1 is connected to the readout electrode portion 117 of a pixel row (R1, Gr1, R1, Gr1, . . . ) in the fourth stage of FIG. 2.

In this manner, the image pickup device using the solid-state image sensing element according to this exemplary embodiment is configured so that color mixing does not occur on the vertical charge transfer paths even when any signal readout method is performed, that is, regardless of whether all pixel readout is performed or not, and regardless of whether any thinning-out readout is performed or not.

Although description has been made by use of the terms “vertical” and “horizontal”, the terms “vertical” and “horizontal” merely mean “one direction” along the surface of the semiconductor substrate and “a direction substantially perpendicular” to the direction.

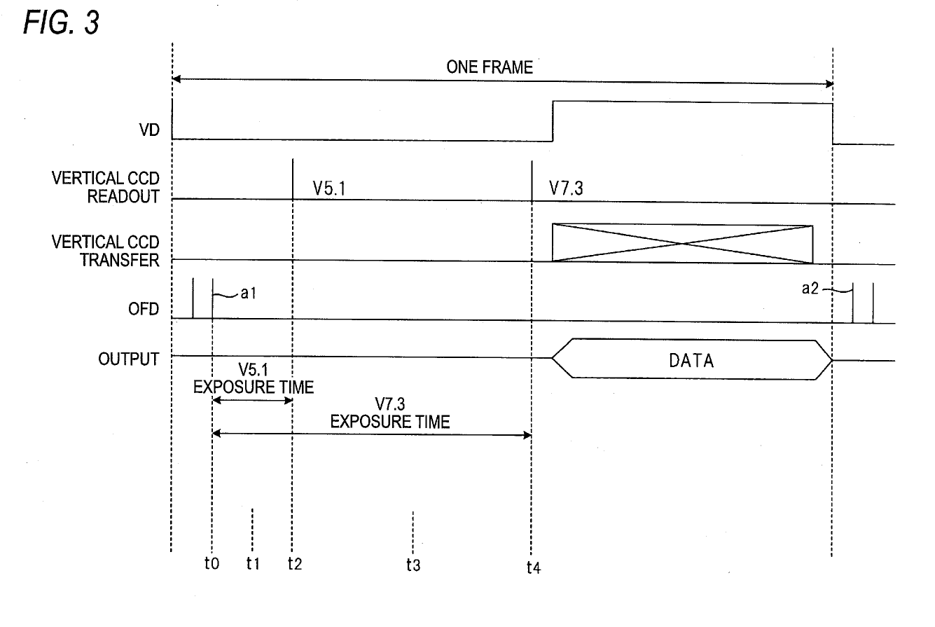

FIG. 3 is a timing chart showing an example of timing for driving the solid-state image sensing element shown in FIG. 2. Driving timing in a wide dynamic range image pickup mode is shown in FIG. 3. First, electronic shutter (OFD) pulses are applied up to time t0 so that unnecessary charges in each pixel 101 are discarded on the semiconductor substrate side. Each pixel 101 starts exposure at the time t0 that application of the electronic shutter pulses a1 is stopped.

When time t1 (under exposure) has passed and it comes time t2, readout pulses are applied to the electrodes V5 and V1 so that charges accumulated in the first pixel group are read out onto the vertical charge transfer paths and stand by in this state. The signal charges read out from the first pixel group and held on the vertical charge transfer paths are signal charges for exposure time t0-t2.

When time t3 (under exposure) has passed and it comes time t4 in this state, readout pulses are applied to the electrodes V7 and V3 this time so that charges accumulated in the second pixel group are read out into the vertical charge transfer paths. The signal charges read out from the second pixel group onto the vertical charge transfer paths are signal charges for exposure time t0-t4.

Then, respective signal charges on the vertical charge transfer paths are transferred along the vertical charge transfer paths and transferred along the horizontal charge transfer path, so that picked-up image signals are outputted from the solid-state image sensing element 100. A picked-up image signal based on short-time exposure (t0-t2) of the first pixel group and a picked-up image signal based on long-time exposure (t0-t4) of the second pixel group are synthesized so that a wide dynamic range image of a subject can be obtained.

After the picked-up image signal based on short-time exposure and the picked-up image signal based on long-time exposure are outputted, electronic shutter pulses a2 are applied again so that unnecessary charges accumulated in the first pixel group after the time t2 are discarded together with unnecessary charges of the second pixel group to the semiconductor substrate side and exposure is restarted at the time point that application of the electronic shutter pulses is stopped.

Although the exemplary embodiment has been described in the case where exposure time of the second pixel group is set to be different from exposure time of the first pixel group, it is a matter of course that a high-definition subject image can be obtained when exposure time of the second pixel group is set to be equal to exposure time of the first pixel group and signal charges of respective pixels are outputted individually to form a picked-up image signal. A high-sensitivity subject image instead of the high-definition subject image may be obtained when signals (read out onto the same vertical charge transfer path) of obliquely adjacent pixels of the same color in the first and second pixel groups are added up.

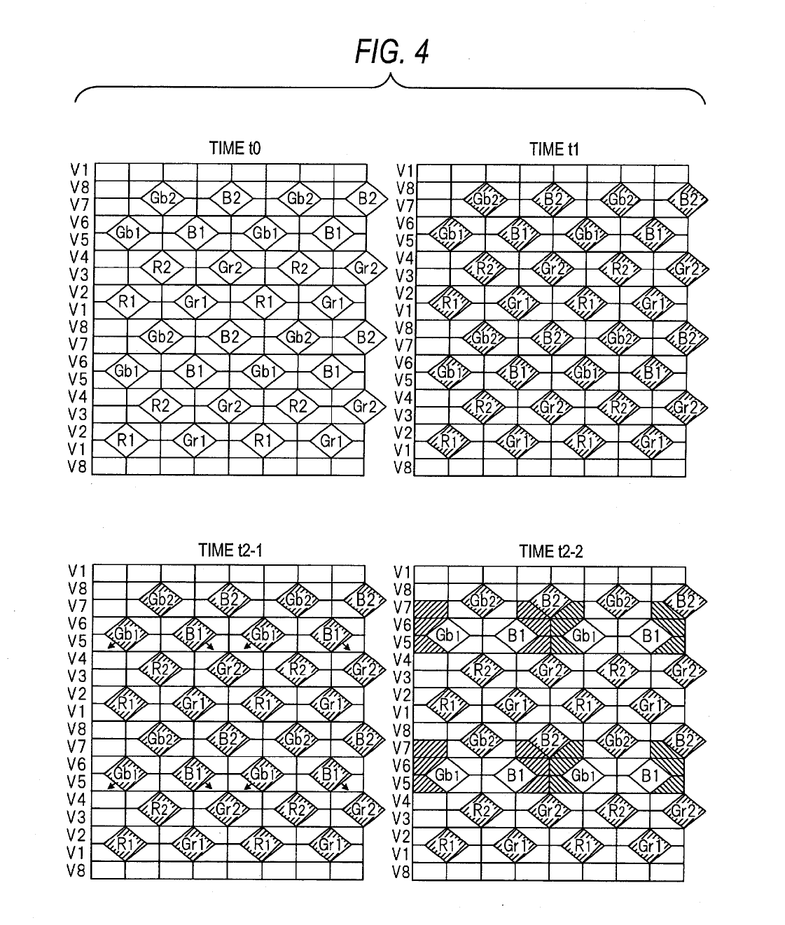

FIG. 4 is a view showing a state where signal charges move on the vertical charge transfer paths in accordance with the driving timing described in FIG. 3. Incidentally, signal charges are present in “hatched” portions.

First, unnecessary charges are discarded to the semiconductor substrate side at time t0 to make respective pixels empty. Signal charges are accumulated in respective pixels at time t1 when exposure is in progress. Although readout pulses are applied to the electrodes V5 and V1 at time t2 explained in FIG. 3, a slight time lag is provided between the time of application of readout pulses to the electrode V5 and the time of application of readout pulses to the electrode V1 for the reason of vertical transfer. The same rule also applies to readout pulses applied to the electrodes V7 and V3 at time t4.

When readout pulses are applied to the electrode V5 at next time t2-1, signal charges are read out onto the vertical charge transfer paths from pixels having the electrode V5 as a readout electrode as shown in time t2-2. In the example shown in FIG. 4, signal charges are read out into each potential packet corresponding to three vertical transfer electrodes.

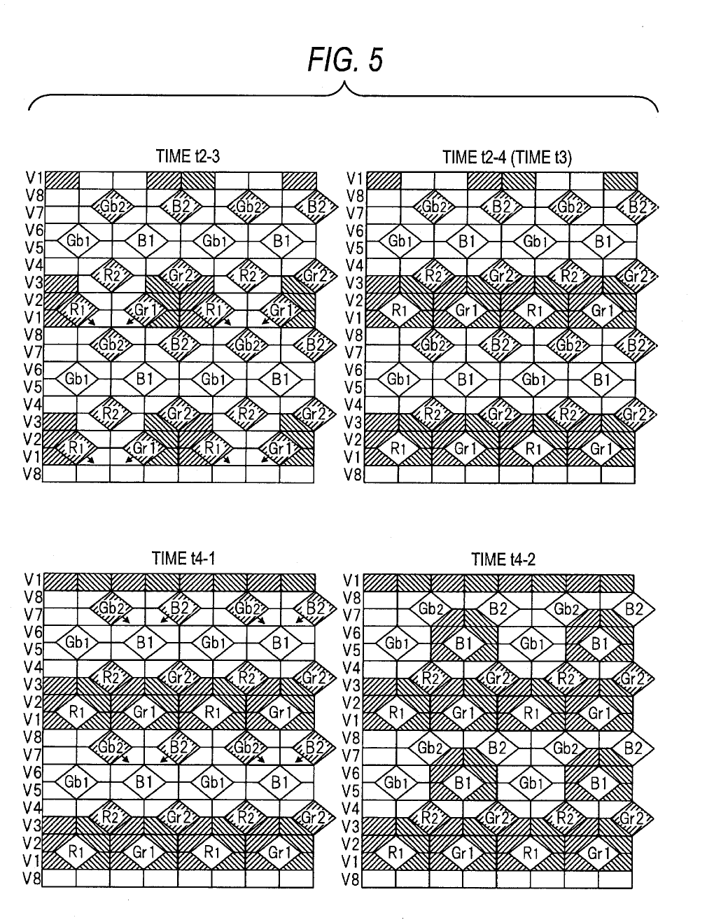

At next time t2-3 shown in FIG. 5, signal charges on the vertical charge transfer paths are transferred vertically by a length corresponding to four transfer electrodes, and then readout pulses are applied to the electrode V1. Consequently, as shown in time t2-4, signal charges of the first pixel group are read out onto the same rows and stand by in this state up to time t4.

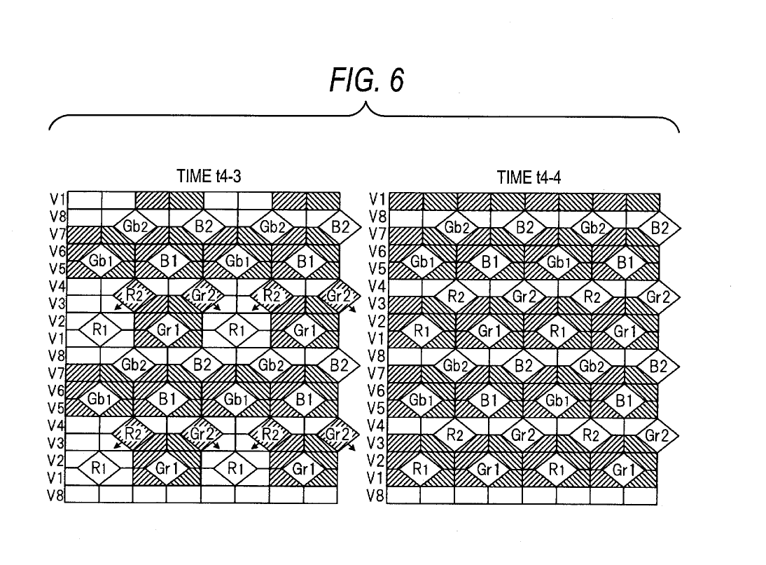

When long-time exposure is completed and readout pulses are applied to the electrode V7 at time t4-1, signal charges are read out onto the vertical charge transfer paths as shown in time t4-2. When signal charges on the vertical charge transfer paths are transferred by a length corresponding to four transfer electrodes as shown in time t4-3 in FIG. 6 and readout pulses are applied to the electrode V3, all signal charges of all pixels are read out individually onto the vertical charge transfer paths as shown in time t4-4. Moreover, because a slight time lag is provided between readout pulses applied to the electrodes V5 and V1 and a slight time lag is provided between readout pulses applied to the electrodes V7 and V3, signal charges of the first pixel group are arranged horizontally in a row and signal charges of the second pixel group are also arranged horizontally in a row.

Thereafter, vertical transfer and horizontal transfer are repeated. In the solid-state image sensing element 100 according to this exemplary embodiment, there is however no risk of color mixing because all signal charges arranged on one and the same vertical charge transfer path are signal charges of the same color.

In this manner, in this exemplary embodiment, picked-up image signals of all pixels are outputted individually from the solid-state image sensing element 10, so that picked-up image signals based on short-time exposure and picked-up image signals based on long-time exposure are added up based on a predetermined addition expression by the digital signal processing portion 26.

Although the driving method explained in FIGS. 4 to 6 is a method in which picked-up image signals of respective pixels are outputted individually from the solid-state image sensing element 100 and added up by the digital signal processing portion 26, signal charges based on long-time exposure and signal charges of the same color based on short-time exposure may be subjected to pixel addition on the vertical charge transfer paths.

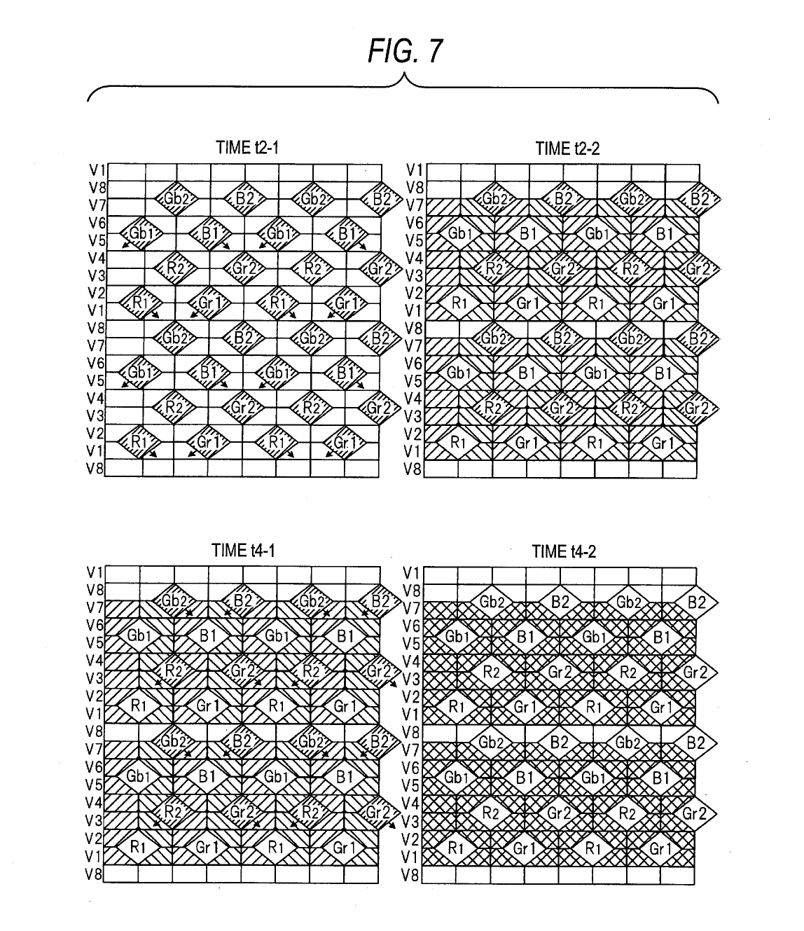

FIG. 7 is an explanatory view showing the case where signal charges of the same color are subjected to pixel addition on the vertical charge transfer paths. First, readout pulses are applied to the electrodes V5 and V1 at time t2 in FIG. 3 so that signal charges detected by respective pixels in the first pixel group based on short-time exposure are read out onto the vertical charge transfer paths. Although FIG. 4 shows the case where a slight time lag is provided between readout pulses applied to the electrodes V5 and V1, readout pulses in this exemplary embodiment may be applied to the electrodes V5 and V1 simultaneously.

Time t2-1 in FIG. 7 is a view showing a readout direction when readout pulses are applied to the electrodes V5 and V1. At next time t2-2, signal charges are read out onto the vertical charge transfer paths respectively and held in a potential packet corresponding to total seven transfer electrodes adjacent to two rows of the first pixel group and two rows of the second pixel group overlapping with the two rows of the first pixel group. These signal charges stand by in this state until long-time exposure completion time t4 comes.

At time t4-1 after the long-time exposure completion time t4, readout pulses are applied to the readout electrodes V7 and V3 of the second pixel group simultaneously so that signal charges of the same color based on long-time exposure of the second pixel group are read out into a potential packet corresponding to seven transfer electrodes in which signal charges based on short-time exposure of the first pixel group are stored, and added up.

Although FIG. 7 has shown the case where signal charges based on short-time exposure of the first pixel group and signal charges based on long-time exposure of the second pixel group are subjected to pixel addition on the vertical charge transfer paths, it is a matter of course that driving shown in FIG. 7 may be applied to the case where exposure time of the second pixel group is set to be equal to exposure time of the first pixel group. For outputting of motion images from the solid-state image sensing element 100, signal charges based on an exposure time of the first pixel group and signal charges based on the same exposure time of the second pixel group may be subjected to pixel addition on the vertical charge transfer paths and outputted so that picked-up images can be outputted at a high frame rate.

Although FIG. 7 has shown pixel addition, driving may be made so that, for example, signal charges of the second pixel group are discarded while only signal charges of the first pixel group are read out. When motion images are picked up, only one of the first pixel group and the second pixel group may be used for picking up motion images in order to improve the frame rate. In this case, the solid-state image sensing element according to this exemplary embodiment may generate a color image because picked-up image signals corresponding to the three colors of RGB are obtained completely by a simple operation of reading out signal charges of the first pixel group (or the second pixel group).

In a recent CCD type solid-state image sensing element in which ten millions or more of pixels are mounted, multi-field readout is used generally because each vertical charge transfer path is narrowed to widen the photo acceptance area of one pixel 101 on a chip as much as possible. Accordingly, to obtain motion images at a high frame rate, pixels are thinned out before motion images are read out from the solid-state image sensing element.

Even in the case where such multi-field readout and pixel thinning-out are performed, the solid-state image sensing element 100 according to this exemplary embodiment may avoid degradation of image quality caused by color mixing because signal charges of the same color are transferred in accordance with each vertical charge transfer path.

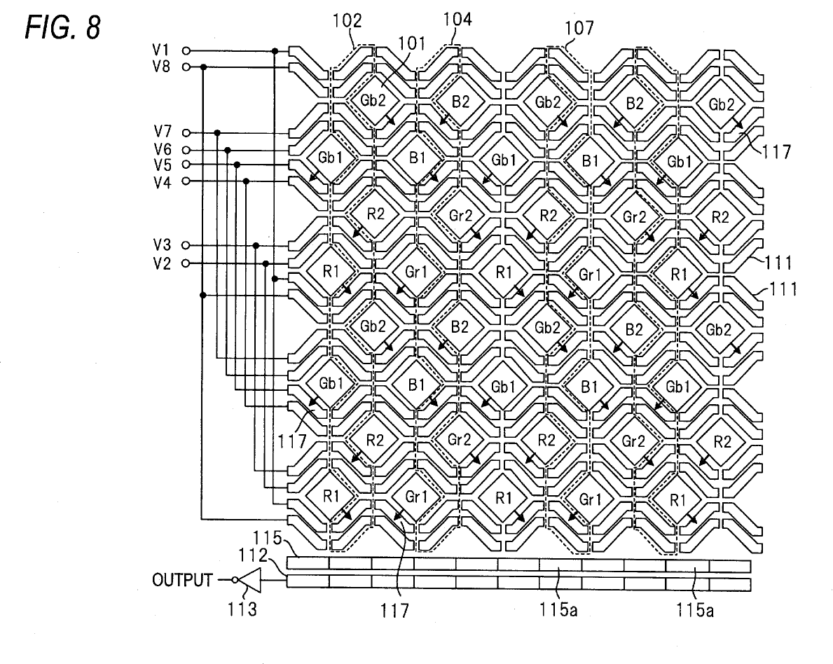

FIG. 8 is a schematic surface view of a solid-state image sensing element according to another exemplary embodiment of the invention. This solid-state image sensing element is the same in basic configuration as the exemplary embodiment shown in FIG. 2 but different in that a line memory (LM) 115 is provided between transfer-direction end portions of vertical charge transfer paths and a horizontal charge transfer path (HCCD).

The line memory 115 has buffer regions 115a which correspond to the vertical charge transfer paths respectively. The line memory 115 has a function of accumulating signal charges received from corresponding vertical charge transfer paths and transferring the signal charges to the horizontal charge transfer path 112 in response to line memory control pulses given from the image pickup element driving portion 24.

When the timing of the pulses for controlling the line memory 115 is adjusted in accordance with the transfer timing of the horizontal charge transfer path 112, signal charges of the same color arranged horizontally may be subjected to pixel addition on the horizontal charge transfer path 112.

In the solid-state image sensing element according to this exemplary embodiment, signal charges transferred by the vertical charge transfer paths can be subjected to pixel addition on the line memory 115 because only signal charges of the same color are transferred by the same vertical charge transfer path.

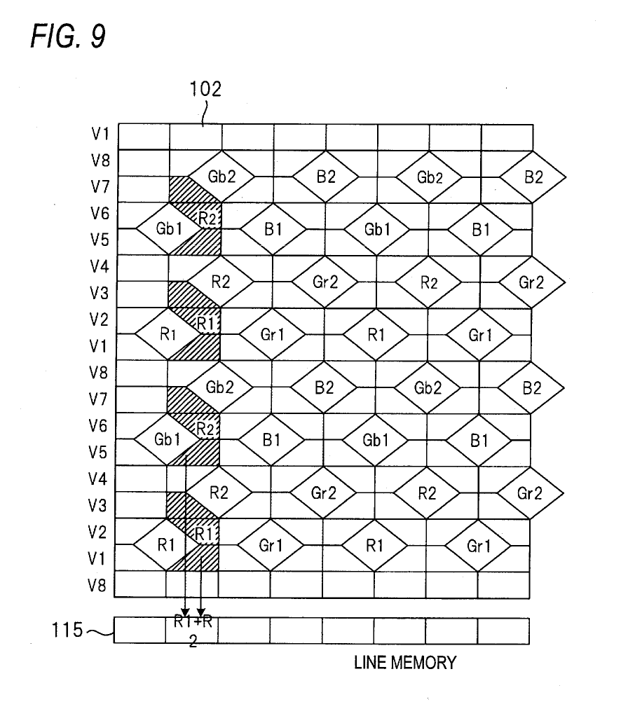

When, for example, a vertical charge transfer path 102 is viewed, the colors of signal charges transferred successively in a state of time t4-4 in FIG. 6 are R1, R2, R1, R2, . . . which are the first pixel group, the second pixel group, the first pixel group, the second pixel group, . . . as a sequence of homochromatic signal charges as shown in FIG. 9. Therefore, when vertical transfer is executed, signal charges of R1 and signal charges of R2 are subjected to pixel addition as R1+R2 while being held in a corresponding buffer region 115a of the line memory 115, then transferred to the horizontal charge transfer path 112.

Although FIG. 9 shows only signal charges of R1, R2, . . . , it is a matter of course that homochromatic signal charges are arranged in order of the first pixel group, the second pixel group, the first pixel group, . . . on any other vertical charge transfer path, and that the signal charges are subjected to pixel addition in a corresponding buffer region 115a of the line memory 115.

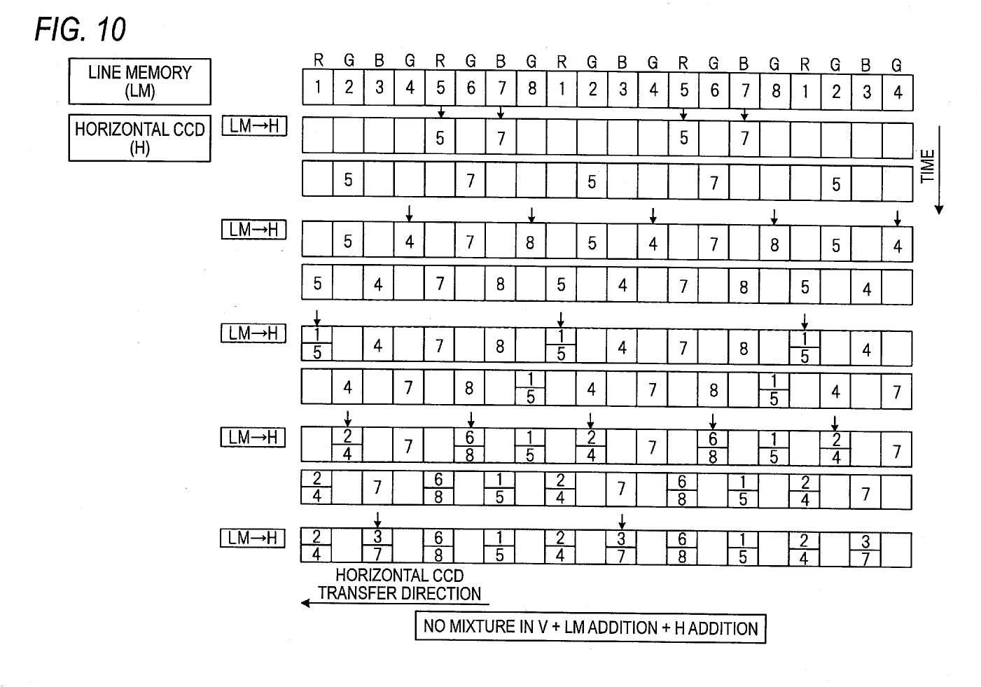

FIG. 10 is an explanatory view showing pixel addition performed on the horizontal charge transfer path 112 based on timing control between the line memory 115 and the horizontal charge transfer path 112. As described above with reference to FIG. 2, in the solid-state image sensing element according to this exemplary embodiment, signal charges of one color are transferred by each vertical charge transfer path. As shown in the uppermost stage of FIG. 10, signal charges of RGBGRGBG . . . are transferred by respective vertical charge transfer paths. Description will be made in the condition that the respective signal charges are numbered as 1(R), 2(G), 3(B), 4(G), . . . , 8(G), 1(R), . . . in left-to-right order.

In a state where signal charges are transferred from the respective vertical charge transfer paths to the line memory 115 so that charges 1 to 8 are held, charges 5(R) and 7(B) are first transferred to the horizontal charge transfer path 112. Then, charges 5(R) are transferred horizontally by three stages and charges 7(B) are transferred horizontally by one stage on the horizontal charge transfer path.

Then, charges 4(G) and 8(G) on the line memory 115 are transferred onto the horizontal charge transfer path, and the horizontal charge transfer path is transferred horizontally by one stage. When charges 1(R) on the line memory are then transferred onto the horizontal charge transfer path, a state where charges 5(R) and 1(R) are subjected to pixel addition on the horizontal charge transfer path is obtained because charges 5(R) are just located on charges 1(R).

After the horizontal charge transfer path is then transferred horizontally by one stage, charges 2(G) and 6(G) on the line memory are transferred to the horizontal charge transfer path. On this occasion, because charges 4(G) and 8(G) have been already located in transfer destinations of charges 2(G) and 6(G), charges 2(G) and 4(G) are subjected to pixel addition and charges 8(G) and 6(G) are subjected to pixel addition.

After the horizontal charge transfer path is then transferred horizontally by one stage, charges 3(B) remaining on the line memory are transferred to the horizontal charge transfer path. On this occasion, because charges 7(B) have been already located in transfer destinations of charges 3(B), charges 3(B) and 7(B) are subjected to pixel addition on the horizontal charge transfer path.

Consequently, homochromatic signal charges of horizontally adjacent two pixels among charges of respective colors shown in the uppermost stage of FIG. 10 are added up on the horizontal charge transfer path.

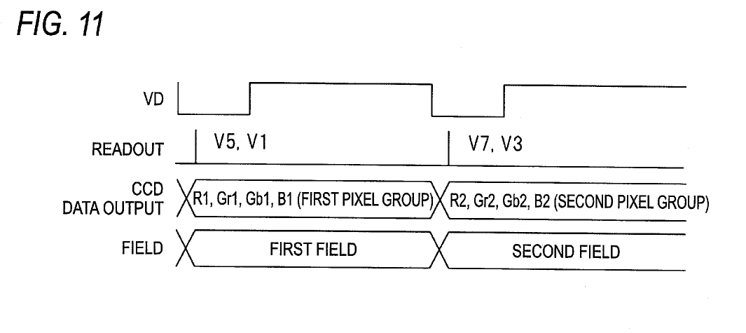

FIG. 11 is a timing chart showing driving timing according to another exemplary embodiment of the invention. In this exemplary embodiment, signal charges of all pixels are read out by every two fields. As described above, exposure time of the first pixel group and exposure time of the second pixel group may be different from each other or may be equal to each other.

First, at the first field, readout pulses are applied to the electrodes V5 and V1 of the first pixel group so that signal charges are read out into the vertical charge transfer paths and transferred so as to be outputted from the solid-state image sensing element. Then, at the second field, readout pulses are applied to the electrodes V7 and V3 of the second pixel group so that signal charges are read out into the vertical charge transfer paths and transferred so as to be outputted from the solid-state image sensing element.

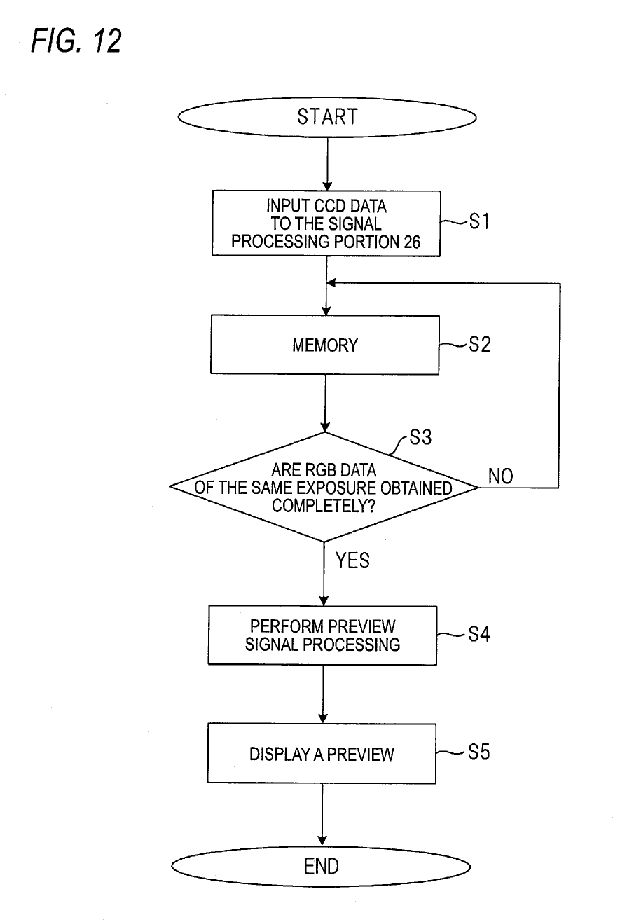

FIG. 12 is a flow chart showing a processing procedure for displaying a confirmation screen (preview) after a still image is picked up. First, picked-up image signals outputted from the CCD type solid-state image sensing element are fetched into the digital signal processing portion 26 (step S1). Then, these picked-up image signals are stored temporarily in the memory 30 (step S2). In next step S3, determination is made as to whether picked-up image signals of the three colors of RGB based on the same exposure time are obtained completely or not. In the case where the picked-up image signals are not obtained completely, picked-up image signals stand by until the picked-up image signals are obtained completely.

When the picked-up image signals of the three colors of RGB based on the same exposure time are obtained completely, processing goes to step S4, in which signal processing for displaying a preview is performed. In next step S5, the preview is displayed on the display portion 28. Thus, this processing is terminated.

In this exemplary embodiment, because picked-up image signals of the three colors of RGB in the first pixel group based on the same exposure time are obtained completely at the first field as shown in FIG. 11, a preview is displayed at a point of time when the picked-up image signals at the first field are fetched into the digital signal processing portion 26 and stored in the memory 30, so that the user can confirm the image by viewing the preview display at a high speed after a still image is picked up.

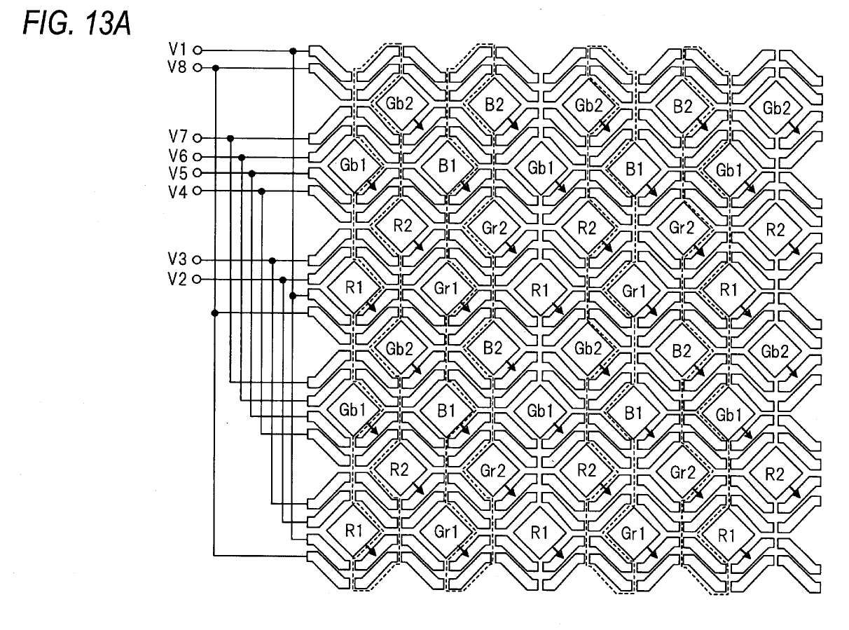

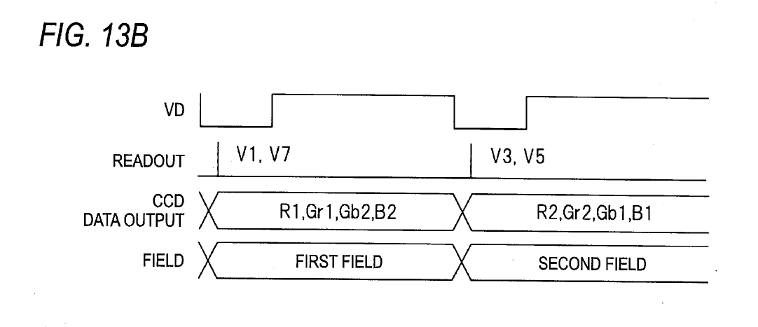

FIGS. 13A and 13B are views for comparing the effect of the exemplary embodiment shown in FIGS. 11 and 12 with that of the background art. FIG. 13A is the same as FIG. 2 in the solid-state image sensing element, the pixel arrangement and the filter arrangement but different from FIG. 2 in the position of each readout electrode portion. In FIG. 13A, respective pixels in the same pixel column are configured so that signal charges are always read out into the vertical charge transfer paths on the right side. As shown in FIG. 13B, in order to read out signal charges from the first and second pixel groups in this solid-state image sensing element according to the background art, readout pulses are applied to the electrodes V1 and V7 at the first field, and readout pulses are applied to the electrodes V3 and V5 at the second field to avoid color mixing.

As a result, picked-up image signals of a part (R1, Gr1) of the first pixel group and picked-up image signals of a part (Gb2, B2) of the second pixel group are read out at the first field, and picked-up image signals of the remaining part (Gb1, B1) of the first pixel group and picked-up image signals of the remaining part (R2, Gr2) of the second pixel group are read out at the second field. Accordingly, it is necessary to wait for completion of the second field to satisfy the requirement of preview display that picked-up image signals of the three colors of RGB based on the same exposure time are obtained completely. On the contrary, in the solid-state image sensing element according to this exemplary embodiment, preview display can be performed after completion of the first field.

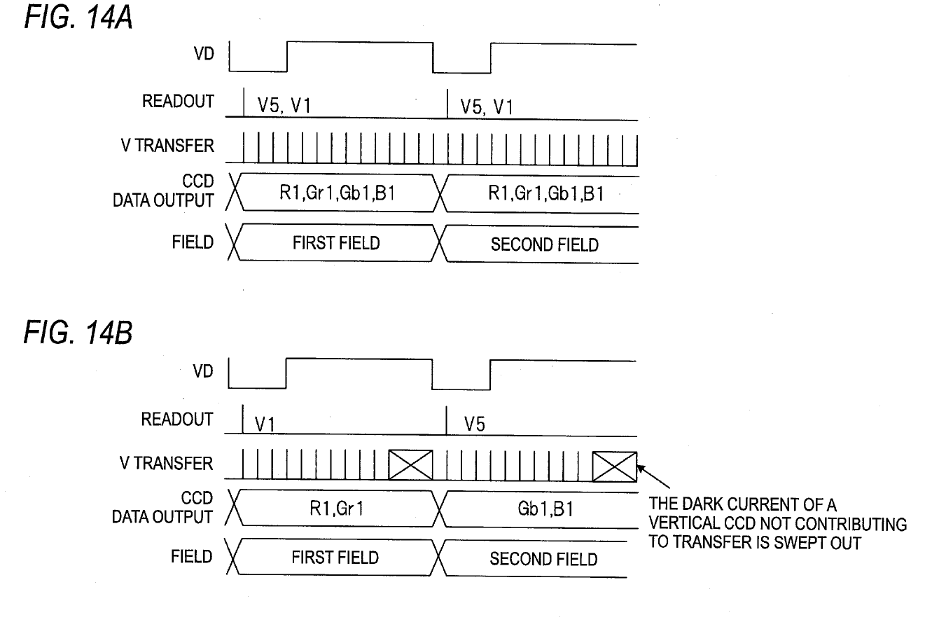

FIG. 14A is a driving timing chart according to a further exemplary embodiment of the invention. FIG. 14B is a driving timing chart according to the background art for the sake of comparison. This example shows a driving method in which only picked-up image signals detected by the first pixel group are read out but signals detected by the second pixel group are not used.

As shown in FIG. 14B, in the solid-state image sensing element (FIG. 13A) according to the configuration of the background art, signals of a part R1 and Gr1 of the first pixel group are read out at the first field and signals of the remaining part Gb1 and B1 of the first pixel group are then read out at the second field in order to avoid color mixing caused by failure in transfer. In addition, the dark current in vertical charge transfer paths not subjected to signal readout/vertical transfer need be swept out at a high speed in the last stage of each field.

On the contrary, as shown in FIG. 14A, in the solid-state image sensing element according to this exemplary embodiment, picked-up image signals of the three colors of RGB are obtained at only the first field and all picked-up image signals of the first pixel group can be read again even at the second field because the solid-state image sensing element has a signal readout structure that signal charges of different colors cannot be read out into one vertical charge transfer path. Thus, the signals of the first pixel group can be read at a speed twice as high as that in FIG. 14B.

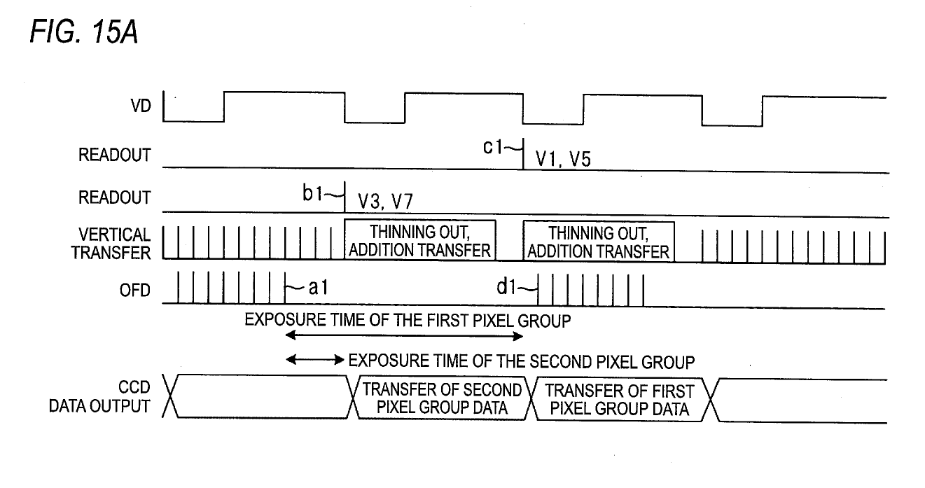

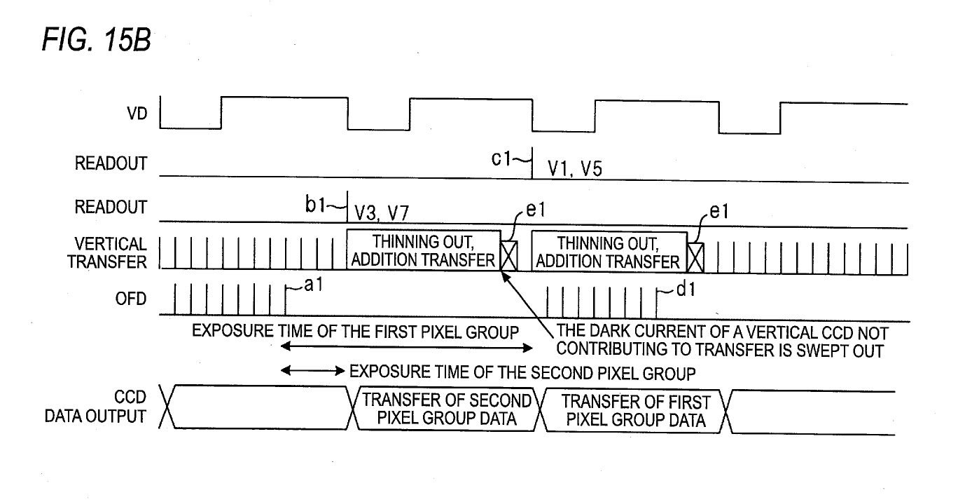

FIG. 15A is a driving timing chart according to a further exemplary embodiment of the invention. FIG. 15B is a driving timing chart according to the background art for the sake of comparison. In this exemplary embodiment, there is shown a driving method in which: long-time exposure is performed on the first pixel group; short-time exposure is performed on the second pixel group; and signal charges are read out at a high speed to thereby create motion images in a wide dynamic range. Incidentally, only one readout portion corresponding to one frame of wide dynamic range motion images is shown in each of FIGS. 15A and 15B.

Exposure starts at stopping of application of electronic shutter pulses a1 and readout pulses b1 are applied to the electrodes V3 and V7 to thereby thin out a half of all pixels and read out only signal charges of the second pixel group into the vertical charge transfer paths. Thus, exposure is completed. The signal charges of the second pixel group are transferred along the vertical charge transfer paths (the aforementioned addition transfer is performed on this occasion) so that the signal charges are outputted as picked-up image signals from the amplifier through the horizontal charge transfer path.

Readout pulses c1 are applied to the electrodes V1 and V5 to thereby thin out a half of all pixels and read out only signal charges of the first pixel group into the vertical charge transfer paths. Thus, exposure of the first pixel group is completed. Electronic shutter pulses d1 are then applied so that unnecessary charges of respective pixels on the semiconductor substrate are discarded in order to the substrate side to wait for fetching of next-frame motion image data.

The signal charges of the second pixel group are transferred along the vertical charge transfer paths (the aforementioned addition transfer is performed on this occasion) so that the signal charges are outputted as picked-up image signals from the amplifier through the horizontal charge transfer path. In this manner, picked-up image signals based on short-time exposure and picked-up image signals based on long-time exposure are obtained, so that wide dynamic range motion images can be obtained while signals detected by all pixels are used.

According to the background art, color mixing occurs when signal charges of the second pixel group are read out and transferred, because it is obvious from FIG. 13A that signal charges of pixels Gb2 and signal charges of pixels R2 are arranged side by side and transferred as charges of different colors in one vertical charge transfer path. Moreover, the dark current enters adjacent vertical charge transfer paths because the adjacent vertical charge transfer paths are vertical charge transfer paths for the first pixel group so that the adjacent vertical charge transfer paths are not used when signal charges of the second pixel group are transferred.

Therefore, as shown in FIG. 15B, high-speed sweep-out driving e1 for sweeping out the dark current is required after signal charges are transferred.

On the contrary, in the solid-state image sensing element according to this exemplary embodiment, color mixing does not occur because the solid-state image sensing element has a physical structure in which only signal charges of the same color are read out onto one vertical charge transfer path when signal charges are read out from respective pixels in any sequence. Accordingly, degradation of image quality caused by color mixing is suppressed so as to be inconspicuous.

In addition, high-speed driving e1 for sweeping out the dark current is not required because signal charges are transferred by all the vertical charge transfer paths when signal charges of the second pixel group are transferred vertically. Accordingly, high-speed readout can be performed compared with the background art, so that the frame rate is improved.

Although FIG. 15A shows an example in which respective picked-up image signals based on short-time exposure and long-time exposure are obtained to create wide dynamic range motion images, the solid-state image sensing element described in the exemplary embodiment may be configured so that picked-up image signals of the three colors of RGB are obtained from only one of the first and second pixel groups to reproduce a color image. Accordingly, when signals detected by the first pixel group and signals detected by the second pixel group are read out alternately at each field to reproduce motion images, as shown in FIG. 11, in such a manner that exposure of the second pixel group is performed while signals detected by the first pixel group are read out, and that exposure of the first pixel group is performed while signals detected by the second pixel group are read out, motion images may be reproduced at a high frame rate.

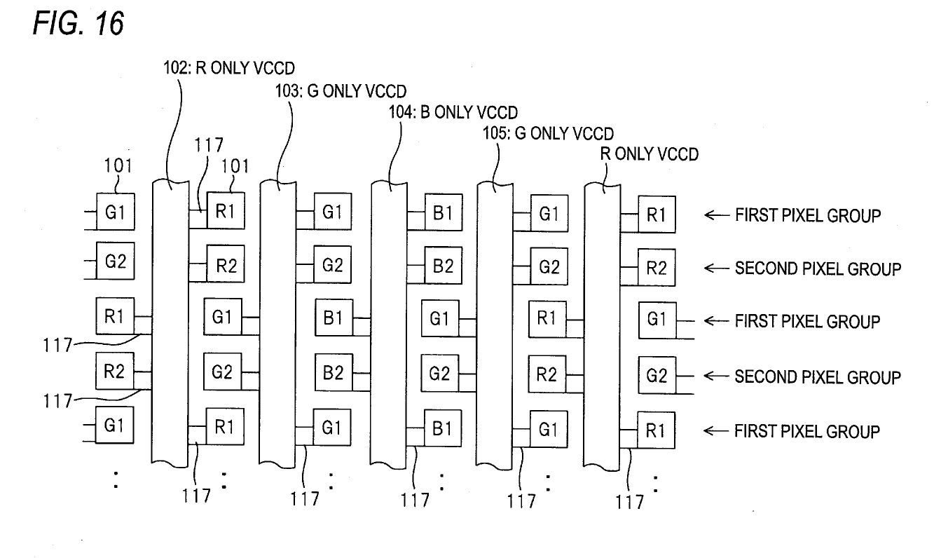

FIG. 16 is a schematic surface view showing the pixel arrangement and the filter arrangement in a CCD type solid-state image sensing element according to another exemplary embodiment of the invention. Although not shown, it is a matter of course that a horizontal charge transfer path is provided. However, a line memory may be provided or may not be provided. As long as pixel addition is performed in the solid-state image sensing element, provision of a line memory makes pixel addition control easy.

In the solid-state image sensing element shown in FIG. 16, respective pixels 101 are arranged in a tetragonal lattice form, and vertical charge transfer paths 102, 103, 104 and 105 are provided along pixel columns respectively. As an arrangement of primary color filters provided to overlap pixels respectively, the same arrangement of GRGBGRGB . . . is laminated on each of two rows of pixels, the same arrangement of RGBGRGBG . . . is laminated on each of next two rows of pixels, the same arrangement of GRGBGRGB . . . is laminated on each of next two rows of pixels, the same arrangement of RGBGRGBG . . . is laminated on each of next two rows of pixels, and the same rule is repeated hereafter.

As a result, color filters of the primary colors of RGB are arranged in accordance with a unit of two vertically continuous pixels of the same color to thereby form a mosaic pattern. For example, two continuous G pixels in the right pixel column and two continuous G pixels in the left pixel column are connected alternately to a vertical charge transfer path only used for G. The same rule also applies to a vertical charge transfer path only used for any other color.

Because an upper one of every two rows which have the same color arrangement is provided as the first pixel group while a lower one of the two rows is provided as the second pixel group, pixels in the first pixel group are called R1, G1 and B1 in which a numeral “1” is given to the color RGB of each of color filters for the first pixel group, and pixels in the second pixel group are called R2, G2 and B2 in which a numeral “2” is given to the color RGB of each of color filters for the second pixel group.

In the example shown in FIG. 16, the vertical charge transfer path 102 is a vertical charge transfer path only used for R signal transfer. Among pixel columns arranged in both sides, each pixel 101 equipped with an R filter is connected to the vertical charge transfer path 102 by a readout electrode portion 117 while each pixel 101 equipped with any other color filter is physically disconnected from the vertical charge transfer path 102 without provision of the readout electrode portion.

The vertical charge transfer path 103 is a vertical charge transfer path only used for G signal transfer. Among pixel columns arranged in both sides, each pixel 101 equipped with a G filter is connected to the vertical charge transfer path 103 by a readout electrode portion 117 while each pixel 101 equipped with any other color filter is physically disconnected from the vertical charge transfer path 103 without provision of the readout electrode portion.

The vertical charge transfer path 104 is a vertical charge transfer path only used for B signal transfer. Among pixel columns arranged in both sides, each pixel 101 equipped with a B filter is connected to the vertical charge transfer path 104 by a readout electrode portion 117 while each pixel 101 equipped with any other color filter is physically disconnected from the vertical charge transfer path 104 without provision of the readout electrode portion.

According to such a configuration, the vertical charge transfer paths are arranged in order of R only, G only, B only, G only, R only, . . . in the same manner as in the exemplary embodiment shown in FIGS. 2 and 8, so that the solid-state image sensing element may be driven by the same method as the method of driving method the solid-state image sensing element described with reference to FIGS. 2 and 8.

Although exemplary embodiments in which primary color filters of RGB are used have been described above, it is a matter of course that each of the aforementioned exemplary embodiments may be applied to a CCD type solid-state image sensing element using cyan, magenta and yellow as three complementary colors.

As described above, the solid-state image sensing element according to an exemplary embodiment includes: pixels formed and arranged as a two-dimensional array on a surface portion of a semiconductor substrate; color filters of colors disposed color by color on the pixels respectively so as to be arranged as a mosaic pattern as a whole; vertical charge transfer paths formed one by one between any two of pixel columns composed of the pixels so that only signal charges of any one of the colors are transferred by each vertical charge transfer path; and readout electrode portions which connect each of the vertical charge transfer paths to pixels arranged in both sides of the vertical charge transfer path and which are provided only between the vertical charge transfer path and the pixels equipped with color filters of the same color as the color transferred by the vertical charge transfer path.

The solid-state image sensing element according to the exemplary embodiment further includes: a line memory having buffer regions which are provided between a horizontal charge transfer path provided along transfer-direction end portions of the vertical charge transfer paths and the vertical charge transfer paths and which temporarily hold signal charges transferred by the vertical charge transfer paths respectively so that the buffer regions correspond to the vertical charge transfer paths respectively.

In the solid-state image sensing element according to the exemplary embodiment, an electrode wiring structure is provided so that the pixels are separated into a first pixel group composed of pixels which are formed and arranged as a two-dimensional array on the surface portion of the semiconductor substrate and a second pixel group composed of pixels which are formed and arranged as a two-dimensional array on the surface portion of the semiconductor substrate so as to be formed as a region overlapping the first pixel group and which are positioned to be shifted from the pixels of the first pixel group respectively, and that signal charges detected by the first pixel group and signal charges detected by the second pixel group are read out separately onto the vertical charge transfer paths.

In the solid-state image sensing element according to the exemplary embodiment, the arrangement of the color filters provided on the first pixel group is the same as the arrangement of the color filters provided on the second pixel group.

In the solid-state image sensing element according to the exemplary embodiment, the first pixel group has the pixels arranged as a tetragonal lattice arrangement and equipped with the color filters arranged as a Bayer arrangement on the tetragonal lattice arrangement, whereas the second pixel group has the pixels provided as to be shifted both vertically and horizontally by a half pixel pitch from the first pixel group and equipped with the color filters arranged as a Bayer arrangement.

The method of driving a solid-state image sensing element according to the exemplary embodiment includes the step of: controlling exposure time of the first pixel group and exposure time of the second pixel group separately.

In the method of driving a solid-state image sensing element according to the exemplary embodiment, signal readout timing of the first pixel group and signal readout timing of the second pixel group are changed to thereby control exposure end time points respectively while points of time that application of electronic shutter pulses is stopped are used as exposure start time points respectively.

The method of driving a solid-state image sensing element according to the exemplary embodiment includes the steps of: reading out signals detected by pixels in the first pixel group at a first field; and reading out signals detected by pixels in the second pixel group at a second field.

The method of driving a solid-state image sensing element according to the exemplary embodiment includes the step of: reading out only signals detected by pixels in one of the first pixel group and the second pixel group while discarding signals detected by pixels in the other pixel group.

The method of driving a solid-state image sensing element according to the exemplary embodiment includes the step of: reading out signals detected by pixels in one of the first pixel group and the second pixel group, and then reading out signals detected by pixels in the other pixel group.

The image pickup device according to the exemplary embodiment is equipped with the aforementioned solid-state image sensing element.

The image pickup device according to the exemplary embodiment includes: the aforementioned solid-state image sensing element; and a control unit which executes the aforementioned solid-state image sensing element driving method.

The image pickup device according to the exemplary embodiment includes: the aforementioned solid-state image sensing element; a control unit which executes the aforementioned solid-state image sensing element driving method; and a signal processing unit which obtains a wide dynamic range image by synthesizing signals which are read out from the first pixel group and the second pixel group in the solid-state image sensing element and which are different in exposure time.

As described above, in accordance with the exemplary embodiments of the invention, there is an effect that a high-quality image of a subject can be picked up without color mixing because only signal charges of the same color are transferred by one and the same vertical charge transfer path.

In addition, a high-definition image, a high-sensitivity image, a wide dynamic range image or high-frame-rate motion images can be picked up in accordance with the purpose of use because a first pixel group and a second pixel group are provided separately so that the first pixel group and the second pixel group can be controlled separately.

### INDUSTRIAL APPLICABILITY

In the CCD type solid-state image sensing element according to the invention, color mixing at the time of vertical transfer is eliminated structurally so that a high-quality image of a subject can be picked up. The CCD type solid-state image sensing element is usefully applied to a digital still camera, a digital video camera, a camera-including cellular phone, a camera-including electronic device, a surveillance camera, an endoscope, an on-vehicle camera, etc.

As described with reference to the exemplary embodiment, there is provided a CCD type solid-state image sensing element in which color mixing does not occur even when a mosaic color filter arrangement is used, a method of driving the CCD type solid-state image sensing element and an image pickup device.

According to the exemplary embodiment, a physical structure in which one vertical charge transfer path is used for transferring only signal charges of the same color is provided so that degradation of image quality caused by color mixing is suppressed even in a CCD type solid-state image sensing element having minute pixels, to thereby make it possible to pick up a color image of a subject with high quality.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

What is claimed is:

1. A solid-state image sensing element comprising:
a plurality of pixels that is formed on one face of a semiconductor substrate in a two-dimensional array arrangement;
a color filter that corresponds to a plurality of colors and includes a plurality of color filter elements disposed color by color on the pixels respectively so as to be arranged as a mosaic pattern as a whole;
a plurality of vertical charge transfer paths that is formed one by one between two of pixel columns composed of the pixels so that each of the vertical charge transfer paths transfers signal corresponding to one of the colors; and
a plurality of readout electrode portions that connects each of the vertical charge transfer paths to pixels arranged in both sides of each of the vertical charge transfer paths and is provided only between the vertical charge transfer path transferring signal corresponding to given color and the pixels on which the color filters corresponding to the given color is disposed.

2. The solid-state image sensing element according to claim 1 further comprising a line memory having buffer regions which are provided between a horizontal charge transfer path provided along end portions of the vertical charge transfer paths at a transfer direction side and the vertical charge transfer paths and which temporarily hold signal charges transferred by the vertical charge transfer paths respectively, the buffer regions is disposed at a position corresponding to the vertical charge transfer paths.

3. The solid-state image sensing element according to claim 1, wherein an electrode wiring structure is provided so that the pixels are separated into a first pixel group composed of pixels which are formed on the one face in a two-dimensional array arrangement and a second pixel group composed of pixels which are formed on the one face in a two-dimensional array arrangement,
a region that the first pixel group is formed is overlapped on a region that the second pixel group is formed,
each pixels of the first pixel group are shifted from each pixels of the second pixel group, and
signal charges detected by the first pixel group and signal charges detected by the second pixel group are read out separately onto the vertical charge transfer paths.

4. The solid-state image sensing element according to claim 3, wherein the arrangement of the colors in the color filters provided on the first pixel group is the same as the arrangement of the colors in the color filters provided on the second pixel group.

5. The solid-state image sensing element according to claim 3, wherein the first pixel group has the pixels arranged as a tetragonal lattice arrangement and equipped with the color filter elements arranged as a Bayer arrangement on the tetragonal lattice arrangement, and
the second pixel group has the pixels provided as to be shifted both vertically and horizontally by a half pixel pitch from the first pixel group and equipped with the color filter elements arranged as a Bayer arrangement.

6. A method for driving a solid-state image sensing element including a first pixel group and a second pixel group, the method comprising controlling exposure time of the first pixel group and exposure time of the second pixel group separately.

7. The method according to claim 6, wherein points of time that application of electronic shutter pulses is stopped are used as exposure start time points respectively and signal readout timing of the first pixel group and signal readout timing of the second pixel group are changed to control exposure end time points respectively.

8. A method for driving a solid-state image sensing element, the method comprising:
reading out signals detected by pixels in the first pixel group at a first field; and
reading out signals detected by pixels in the second pixel group at a second field.

9. A method for driving a solid-state image sensing element including a first pixel group and a second pixel group, the method comprising reading out only signals detected by pixels in one of the first pixel group and the second pixel group while discarding signals detected by pixels in the other pixel group.

10. A method for driving a solid-state image sensing element including a first pixel group and a second pixel group, the method comprising:
reading out signals detected by pixels in one of the first pixel group and the second pixel group, and
reading out signals detected by pixels in the other pixel group.

11. An image pickup device comprising a solid-state image sensing element that includes:
a plurality of pixels that is formed on one face of a semiconductor substrate in a two-dimensional array arrangement;
a color filter that corresponds to a plurality of colors and include a plurality of color filter elements disposed color by color on the pixels respectively so as to be arranged as a mosaic pattern as a whole;
a plurality of vertical charge transfer paths that is formed one by one between two of pixel columns composed of the pixels so that each of the vertical charge transfer paths transfers signal corresponding to one of the colors; and
a plurality of readout electrode portions that connects each of the vertical charge transfer paths to pixels arranged in both sides of each of the vertical charge transfer paths and is provided only between the vertical charge transfer path transferring signal corresponding to given color and the pixels on which the color filters corresponding to the given color is disposed.
